(19) United States
(12) Patent Application Publication
(10) Pub. No.: US 2013/0346386 A1
(43) Pub. Date: Dec. 26, 2013

(54) TEMPORAL TOPIC EXTRACTION

(71) Applicants: FERNANDO PAIVA ZANDONA, Sammamish, WA (US); SEVERAN SYLVAIN JEAN-MICHEL RAULT, REDMOND, WA (US); LAWRENCE BRIAN RIPSHER, SEATTLE, WA (US)

(72) Inventors: FERNANDO PAIVA ZANDONA, Sammamish, WA (US); SEVERAN SYLVAIN JEAN-MICHEL RAULT, REDMOND, WA (US); LAWRENCE BRIAN RIPSHER, SEATTLE, WA (US)

(73) Assignee: MICROSOFT CORPORATION, REDMOND, WA (US)

(21) Appl. No.: 13/530,495

(22) Filed: Jun. 22, 2012

(51) Int. Cl. G06F 17/30

(52) U.S. Cl. 707/709; 707/769; 707/E17.108

(57) ABSTRACT

Methods, computer systems, and computer-storage media for forming a topic graph with at least one temporal element are provided. URL-query pairs are received and a topic graph is formed comprising the URL-query pairs. At least one topic associated with a URL and an importance of each topic is identified. In embodiments, a list of top topics is identified.

### BACKGROUND

Various methods for search and retrieval of information, such as by a search engine over a wide area network, are known in the art. Search engine systems store, process, and index content that has value for end-users.

Information extraction is sometimes used to extract structured information from unstructured and/or semi-structured sources. For example, entity extraction can be used to locate and classify elements of text into structured topics. Current approaches to entity extraction are batch (i.e., offline) and accomplished based on feed ingestion or web site scraping. These approaches are largely inefficient and require significant resources. In addition, such approaches are prone to manipulation and often result in insignificant or undesired information.

Further, entity extraction algorithms currently utilized are not dependent on temporal variables. This results in static relationships between unstructured queries and entities, or among entities.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to methods, systems, and computer readable media for identifying a list of top topics based on uniform resource locator (URL)-query pairs and temporal elements. In one embodiment, computer storage media storing computer-useable instructions, that, when executed, perform a method for forming a topic graph with at least one temporal element are provided. URL-query pairs are received. A topic graph comprising the URL-query pairs is formed. At least one topic associated with a URL is identified. An output temporal element is received. An importance of each topic to the URL for the output temporal element is identified.

In another embodiment, computer storage media storing computer-useable instructions, that, when executed, perform a method for creating a list of top topics through URL semantic information are provided. A click stream is harvested for URL-query pairs and a temporal element is received. A list of top topics based on the URL-query pairs and the temporal element is identified.

In yet another embodiment, a computer system, comprising a processor coupled to a computer-storage medium, the computer-storage medium having stored thereon a plurality of computer software components executable by the processor, for forming a topic graph with at least one temporal element is provided. A URL-query component receives URL-query pairs. A graph component forms a topic graph comprising the URL-query pairs. A topic component identifies at least one topic associated with a URL. A temporal component receives at least one temporal element. An importance component determines an importance of each topic to the URL for the temporal element.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 schematically shows a network environment suitable for performing embodiments of the invention.

FIG. 3 is a flow diagram showing a method for forming a topic graph with at least one temporal element, in accordance with an embodiment of the present invention; and

FIG. 4 is a flow diagram showing a method for creating a list of top topics through URL semantic information, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The following definitions are used to describe aspects of temporal topic extraction. A URL Topic is a subject associated with a particular URL. In other words, the URL Topic is the subject of the web page a specific URL points to. The URL may have more than one topic associated with it. Further, the URL may have an associated score, or importance, informing how important a particular topic is to the URL (i.e., the probability of the topic given the URL). Topic Providers are information retrieval models created based on specific URLs, usually part of a specific domain, of a topic graph. Click stream represents URLs that users of a search engine click as a result of a particular search or query. Stop words are used to remove terms that are too common in the corpus (e.g., “the”, “a”, etc.).

Embodiments of the present invention relate to systems, methods, and computer storage media having computer-executable instructions embodied thereon that form a topic graph with at least one temporal element. In this regard, embodiments of the present invention provide an understanding of topics associated with URLs. Understanding the topics associated with various text and URLs allows for new features and optimizations, without any knowledge of website content, such as topic graphs, improved targeted advertising and relevance, recommendations, semantic understanding, top things lists, temporal dependent topic graphs, time-lapse URL clustering, and the like.

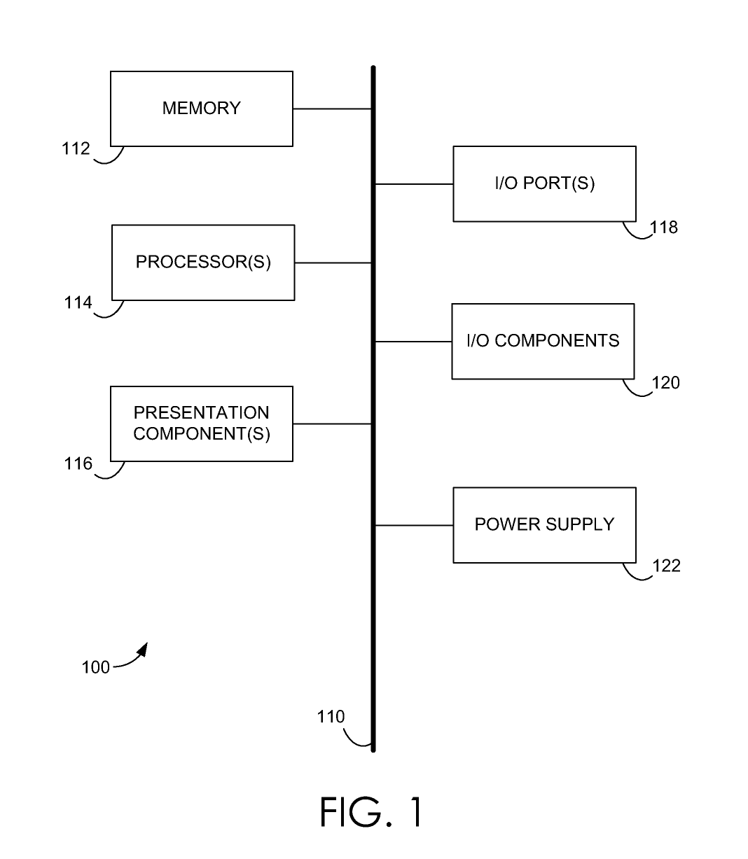

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation”, “server”, “laptop”, “hand-held device”, “server farm”, “cloud computing”, “distributed systems”, etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

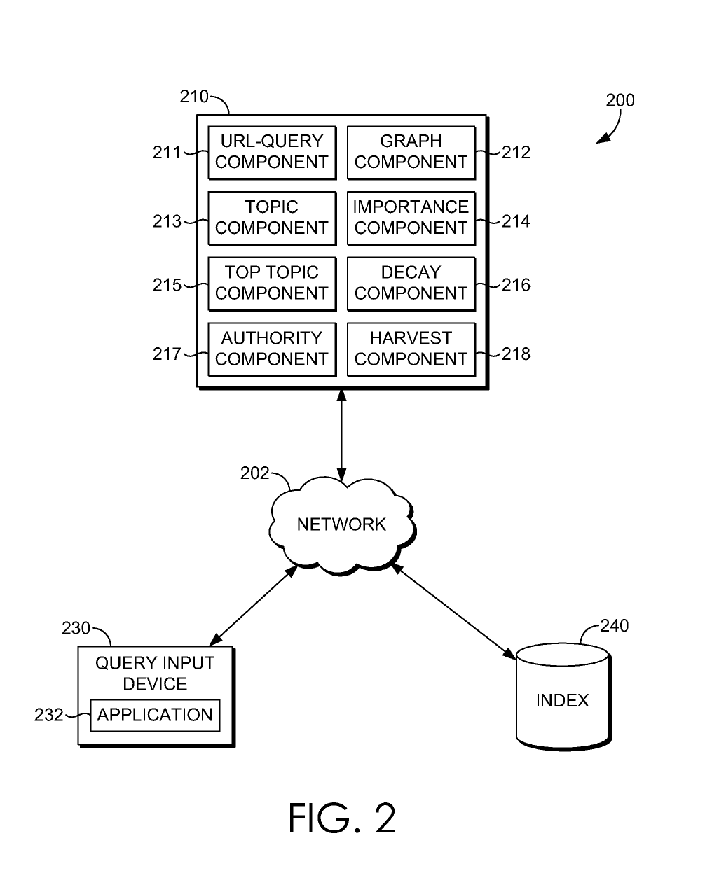

With reference to FIG. 2, a block diagram is illustrated that shows an exemplary computing environment 200 configured for use in implementing embodiments of the present invention. It will be understood and appreciated by those of ordinary skill in the art that the environment 200 shown in FIG. 2 is merely an example of one suitable environment and is not intended to suggest any limitation as to the scope of use or functionality of the present invention. Neither should the environment 200 be interpreted as having any dependency or requirement related to any single module/component or combination of modules/components illustrated therein.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

FIG. 2 schematically shows a computing system architecture 200 suitable for performing embodiments of the invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

With continued reference to FIG. 2, the computing system architecture 200 includes a network 202, a temporal topic extraction server 210, a query input device 230, and an index 240. The network 202 includes any computer network such as, for example and not limitation, the Internet, an intranet, private and public local networks, and wireless data or telephone networks.

The query input device 230 is any computing device, such as the computing device 100, capable of running an application 232, from which a search query can be initiated.

In one embodiment, the search query is an actual URL (i.e., to find topics associated to the URL). For example, the query input device 230 might be a personal computer, a laptop, a server computer, a wireless phone or device, a personal digital assistant (PDA), or a digital camera, among others. It should be noted, however, that embodiments are not limited to implementation on such computing devices, but may be implemented on any of a variety of different types of computing devices within the scope of embodiments hereof. In an embodiment, a plurality of query input devices 230, such as thousands or millions of query input devices 230, is connected to the network 202.

The temporal topic extraction server 210 includes any computing device, such as the computing device 100, and provides at least a portion of the functionalities for temporal topic extraction. In an embodiment a group of temporal topic extraction servers 210 share or distribute the functionalities for providing temporal topic extraction for a user population.

Components of the query input device 230 and the temporal topic extraction server 210 may include, without limitation, a processing unit, internal system memory, and a suitable system bus for coupling various system components, including one or more databases for storing information (e.g., files and metadata associated therewith). Each of the query input device 230 and the temporal topic extraction server 210 typically includes, or has access to, a variety of computer-readable media.

The temporal topic extraction server 210 is communicatively coupled to an index 240. The index 240 includes any available computer storage device, or a plurality thereof, such as a hard disk drive, flash memory, optical memory devices, and the like. The index 240 provides an index for identifying URL-query pairs available via network 202. The index 240 may utilize any indexing data structure or format. When harvesting the click stream for URL-query pairs, the data is organized according to a temporal element (e.g., minute, hour, day, week, month, etc.). In an embodiment, the temporal topic extraction server 210 and index 240 are directly communicatively coupled so as to allow direct communication between the devices without traversing the network 202.

It will be understood by those of ordinary skill in the art that computing system architecture 200 is merely exemplary. While the temporal topic extraction server 210 is illustrated as a single unit, one skilled in the art will appreciate that the search engine server 210 is scalable. For example, the temporal topic extraction server 210 may in actuality include a plurality of computing devices in communication with one another. Moreover, the index 240, or portions thereof, may be included within the temporal topic extraction server 210. The single unit depictions are meant for clarity, not to limit the scope of embodiments in any form.

As shown in FIG. 2, temporal topic extraction server 210 includes a URL-query component 211, a graph component 212, a topic component 213, and an importance component 214. In various embodiments, temporal topic extraction server 210 further includes a top topic component 215, a decay component 216, an authority component 217, and a harvest component 218.

URL-query component 211 receives URL-query pairs. The URL-query pairs are contained in the click stream, a log of all URL-query pairs and corresponding click-through rates (CTR). Graph component 212 forms a topic graph comprising the URL-query pairs. The URLs and the queries comprise the nodes of the topic graph. The number of impressions or clicks comprises the edges connecting the nodes. Given a URL, the topic graph allows for a quick determination of all queries associated with that particular URL. Further, the topic graph allows for a simple determination of the importance of a particular URL-query pair. The importance can be quantified, in one embodiment, by the CTR.

Topic component 213 identifies at least one URL Topic, or topic, associated with a URL. For example, given the following URL, three topics may be extracted, along with various probabilities associated with each topic:

http://www.example.com/black-friday-2012-anystore-computer-brand-begin-countdown-to-holiday-shopping-date-59591

Given the above URL, the three topics may include “black Friday shopping”, “laptop”, and “Anystore”. Further probabilities associated with each topic may be assigned as follows: black Friday shopping (0.72), laptop, (0.69), and Anystore (0.62). It is important to emphasize that the webpage the URL points to is not visited in order to extract the topics. Rather, the topics are extracted only utilizing the click stream and the topic providers

The topic graph helps to identify URLs that are directly connected, through associated queries. These connections further provide insight on the topics of various pages. For example, URLs connected to Wikipedia, through queries, can be used as generic and directly connected topic providers because Wikipedia URLs contain enough information in itself (i.e., the Wikipedia entry title in the URL). This is illustrated using the following example:

http://www.sportsinformationstie.com/college-football/heisman11

The above URL may be directly connected to several Wikipedia pages including:

http://en.wikipedia.org/wiki/List_of_Heisman_Trophy_winners

http://en.wikipedia.org/wiki/Sports_Information_Site_College_Football

http://en.wikipedia.org/wiki/Heinsman_Trophy

From the above URLs, topics and scores can be extracted, by utilizing Maximum Likelihood Estimation on the clicks, associated with the Sports Information Site URL. In this example, the topics are “list of Heisman trophy winners”, Sports Information Site college football”, and “Heisman trophy”. As can be appreciated, many other topic providers can be used similarly to the Wikipedia example illustrated above. These topic providers may provide additional semantic information to the topics.

Temporal component 214 receives at least one temporal element. Because the semantic data is extracted from the click stream by URL-query component 211, time can be added to the information providing a temporal element to the results. Thus, a temporal topic graph can be built where URLs are connected to different topics not only based on the raw URL-query pair structure, but also based on the results of temporal input data and temporal topic providers. In one embodiment, the temporal element is received before creating the topic provider. The click stream data is broken into time intervals to create different correlations between the URLs and the queries. This allows a topic provider that correlates URLs and queries over a specific timeframe. Several topic providers can be built based on these time intervals. Thus, given a URL, the topic provider returns topics based on what has been relevant during the timeframe the URL-query pairs were selected.

In another embodiment, the temporal element is received after creating the topic graph. The topic graph in this instance is created with all available click stream data and a specific timeframe is selected for the URL-query pairs as input. In yet another embodiment, the temporal element is received for both the input data and the before creating the topic graph.

Importance component 215 identifies an importance of each topic to the URL for the temporal element. As previously described herein, the importance of each topic to a particular URL can be quantified with a score indicating the probability of a topic given the URL. As can be appreciated, the temporal element may influence the score. Importance component 215 takes the temporal element into consideration when identifying the importance. For example, the CTR is likely influenced by a particular timeframe. Thus, depending on the temporal element received by temporal component 214, the CTR may fluctuate. Importance component 215 considers the specific CTR for the temporal element when identifying the importance for a particular timeframe corresponding to the temporal element. The importance is added to the edge connecting the URL and topic nodes.

In one embodiment, a top topic component 216 identifies a list of top topics based on only the URL-query pairs and the temporal element (i.e., the content of the web site is not used to create the list). For example, a list of top video games can be created using an all-time video game topic provider (i.e., no temporal element for the topic provider) based on IGN.com and a temporal click stream sample (e.g., the last 7 days).

In another embodiment, URLs can be clustered based on semantic information or topics. This provides an alternative to other similarity clustering algorithms. Further, any topic provider can be used on the clustering URLs. For example, URLs can be clustered based on a generic topic provider (e.g., Wikipedia) or a domain specific topic provider (e.g., a games or movies topic provider).

In another embodiment, decay component 217 adds a decay function to the importance. The decay function reduces the URL-topic score (i.e., importance) as time goes by because something that was important in a previous day, week, or month may be less important the following day, week, or month.

In one embodiment, authority component 218 identifies a topic authority. For instance, a number of URLs may be directly connected, through associated queries, with a particular URL. As described herein, Wikipedia meets these criteria and is identified by authority component 218 as a topic authority. As can be appreciated, other URLs that meet these criteria are similarly identified by authority component 218 as a topic authority. For example, URLs associated with IGN.com can be used, in one embodiment, to create a games topic provider.

In some instances, areas of the topic graph may be sparse and not directly connected to a topic provider. To overcome this, a generic topic provider based on a topic provider (e.g., Wikipedia) can be built. Topic graph data is harvested by harvest component 218, in one embodiment, for all URLs associated with a topic provider and matching a specific regular expression or patterns. For each URL, all associated queries (URL-query pairs) are selected. Similar URLs are grouped together into a single URL-to-queries tree. An information retrieval model is built using the URLs as document identifications (IDs) and the queries as the corpus of the document. In various embodiments, the information retrieval model is created using TF-IDF, probabilistic language models, BM25 and its variations, and the like. A list of domain specific stop words is also accepted, in one embodiment. For example, a games topic provider may contain all the generic stop words (e.g., “the”, “a”, “is”, etc.) as well as game-specific stop words (e.g., “game”, “video”, etc.). In one embodiment, all document terms are stemmed using the Porter stemmer. Higher importance is also given to URL-query pairs with a higher CTR.

In some instances, topics associated with a URL are not easily ascertainable though the directly connected topics. For example, the following URL may be used as input:

http://www.msnbc.msn.com/id/45034780

However, based on the URL-query pairs, it is clear that the topics associated with the URL include “refinancing”, “home affordable modification program”, and “mortgage modification”.

In another embodiment, a domain specific provider is utilized by choosing a domain authority. This is similar to the topic authority approach described above; however, rather than using URLs connected to a topic authority, a domain authority is used as the source of URL-query pairs to build the topic graph. For example, ign.com can be utilized as the source of URL-query pairs to build a topic graph for video games. Similarly, imdb.com can be utilized as the source of URL-query pairs to build a topic graph for movies. Using movies as an example, all URLs matching the regular expression http://www.imdb.com/title/ttf[\d]+ are harvested and the topic graph is built to map queries to, in this case, movie entries in the IMDb database.

In one embodiment, classifiers are built to augment the topic extraction model. For example, a classifier can be used in front of the extraction model to influence the score of a topic. Classifiers are used to determine if a query is part of a specific domain. For example, before sending a query to the games topic provider, the query can initially be sent to a “games domain classifier” to check if that query is in any way related to the “games domain”. The “games topic provider” will only be executed or queried if the query is part of that domain. In one embodiment, classifiers return a value between 0 and 1. A threshold can be selected so the query is only executed if the threshold is met.

In one embodiment, domain topic providers are extended to use the domain authority's semantic webpage markup. In various embodiments, OpenGraph, RDF, schema.org, and the like, are used to further extract semantic data for the topic. Continuing the IMDb example, once the most probable IMDb entries are returned, at real-time (but asynchronously), IMDb pages are fetched and parsed for OpenGraph data. This data provides structured information about the topic allowing domain topic providers to be quickly built, requiring only the provider's name, the regular expression describing the domain specific URL and a list of stop words. In other words, given a URL, a set of generic and domain specific topics (and their semantic properties) can be extracted in real-time.

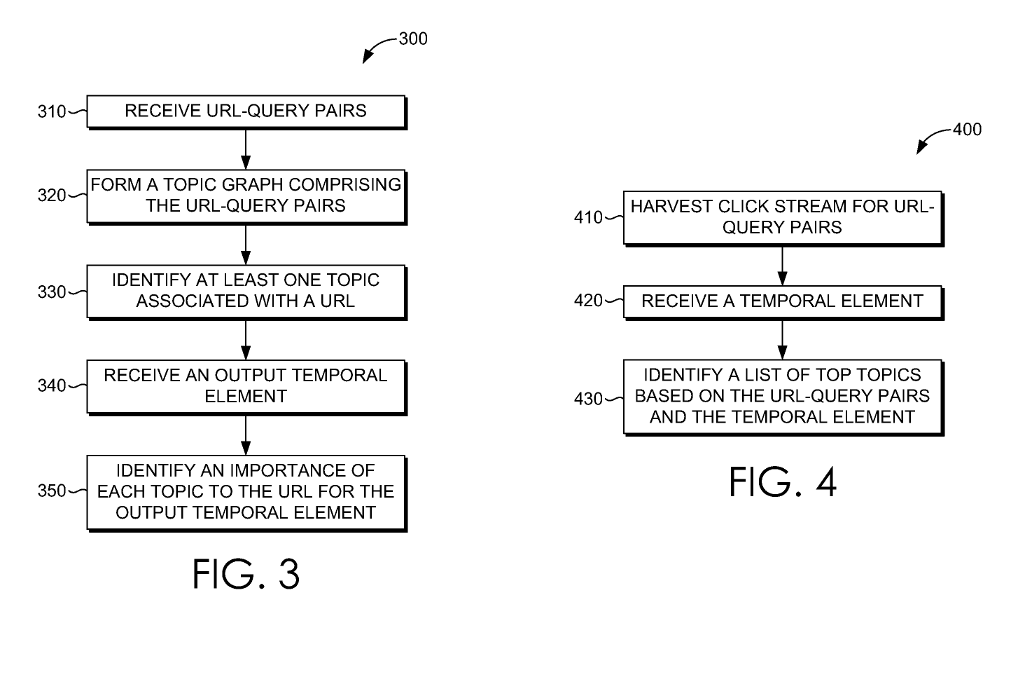

Referring now to FIG. 3, a flow diagram 300 illustrates a method for forming a topic graph with at least one temporal element, in accordance with an embodiment of the present invention. At step 310, URL-query pairs are received. In one embodiment, an input temporal element is received. In one embodiment, the input temporal element represents a relevance of the URL-query pair at the time the URL-query pair was collected. A topic graph comprising the URL-query pairs is formed at step 320. In one embodiment, the URLs and queries represent the nodes of the topic graph. In one embodiment, similar URLs are grouped into a single URL-to-queries tree. In one embodiment, an information retrieval model is built using the URLs as document IDs and the queries as a corpus of a document. At step 330, at least one topic associated with a URL is identified. In one embodiment, a number of impressions represent the edges connecting the nodes. In one embodiment, a topic authority is identified. In one embodiment, the topic authority is a domain specific provider. In one embodiment, the topic graph is harvested for all topic authority URLs matching a specific regular expression. In one embodiment, all associated URL-query pairs are selected. At step 340, an output temporal element is received. An importance of each topic to the URL for the output temporal element is identified at step 350. In one embodiment, a classifier is utilized to augment the importance. In one embodiment, a decay function is added to the importance.

Referring now to FIG. 4, a flow diagram 400 illustrates a method creating a list of top topics through URL semantic information, in accordance with an embodiment of the present invention. At step 410, a click stream is harvested for URL-query pairs. In one embodiment, URLs are clustered based on topics. A temporal element is received at step 420. A list of top topics is identified, at step 430, based on the URL-query pairs and the temporal element.

It will be understood by those of ordinary skill in the art that the order of steps shown in the method 300 and 400 of FIGS. 3 and 4 respectively are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. Computer-storage media storing computer-useable instructions, that, when executed by a computing device, perform a method for forming a topic graph with at least one temporal element, the method comprising:
receiving URL-query pairs;
forming a topic graph comprising the URL-query pairs;
identifying at least one topic associated with a URL;
receiving an output temporal element; and
determining an importance of each topic to the URL for the output temporal element.

2. The media of claim 1, wherein URLs and queries represent the nodes of the topic graph.

3. The media of claim 2, wherein a number of impressions represent the edges connecting the nodes.

4. The media of claim 1, further comprising identifying a topic authority.

5. The media of claim 1, further comprising harvesting the click graph for all topic authority URLs matching a specific regular expression.

6. The media of claim 1, further comprising selecting all associated URL-query pairs.

7. The media of claim 1, further comprising grouping similar URLs into a single URL-to-queries tree.

8. The media of claim 1, further comprising building an information retrieval model using the URLs as document IDs and the queries as a corpus of a document.

9. The media of claim 4, wherein topic authority is a domain specific provider.

10. The media of claim 1, further comprising utilizing a classifier to augment the importance.

11. The media of claim 1, further comprising receiving an input temporal element.

12. The media of claim 11, wherein the input temporal element represents a relevance of the URL-query pair at the time the URL-query pair was collected.

13. The media of claim 1, further comprising adding a decay function to the importance.

14. Computer-storage media storing computer-useable instructions, that, when executed by a computing device, perform a method for creating a list of top topics through URL semantic information, the method comprising:
harvesting a click stream for URL-query pairs;
receiving a temporal element; and
identifying a list of top topics based on the URL-query pairs and the temporal element.

15. The media of claim 14, further comprising clustering URLs based on topics.

16. A computer system for forming a topic graph with at least one temporal element, the computer system comprising a processor coupled to a computer-storage medium, the computer-storage medium having stored thereon a plurality of computer software components executable by the processor, the computer software components comprising:
a URL-query component for receiving URL-query pairs;
a graph component for forming a topic graph comprising the URL-query pairs;
a topic component for identifying at least one topic associated with a URL;
a temporal component for receiving at least one temporal element; and
an importance component for determining an importance of each topic to the URL for the temporal element.

17. The computer system of claim 16, further comprising a top topic component for identifying a list of top topics based on the URL-query pairs and the temporal element.

18. The computer system of claim 16, further comprising a decay component for adding a decay function to the importance.

19. The computer system of claim 16, further comprising an authority component for identifying a topic authority.

20. The computer system of claim 16, further comprising a harvest component for harvesting the topic graph for all topic provider URLs matching a specific regular expression.
